(19) United States
(12) Patent Application Publication
(10) Pub. No.: US 2019/0188119 A1
(43) Pub. Date: Jun. 20, 2019

(54) SYSTEM AND A METHOD FOR PROVIDING AUTOMATED PERFORMANCE DETECTION OF APPLICATION PROGRAMMING INTERFACES

(71) Applicant: Cognizant Technology Solutions India Pvt. Ltd., Chennai (IN)

(72) Inventors: Sasikumar Chandanam Kumarath, Bengaluru (IN); Nishore Chandrabhanu Leela, Bengaluru (IN)

(21) Appl. No.: 15/902,426

(22) Filed: Feb. 22, 2018

(30) Foreign Application Priority Data
Dec. 14, 2017 (IN) 201741044932

(51) Int. Cl. G06F 11/36; G06F 11/34

(52) U.S. Cl. CPC G06F 11/3688; G06F 11/3409

(57) ABSTRACT

A system and a method for automating performance detection of one or more application programming interfaces (APIs) is provided. The present invention provides for retrieving one or more test cases and associated test data as per respective test case ID's and generate one or more test requests by applying a data enrichment technique. Further, the present invention provides for executing one or more generated test requests on an API under test, analyze a response received from the API under test, perform response validation, detect any defects in the API based on the received response, and generate a detailed report of the executed test request. Furthermore, the present invention provides a visual interface for selecting test cases, creating test cases, editing test cases, editing test requests, display execution of test requests and test reports.

### FIELD OF THE INVENTION

This application is related to and claims the benefit of Indian Patent Application Number 201741044932 filed on Dec. 14, 2017, the contents of which are herein incorporated by reference in their entirety.

### BACKGROUND OF THE INVENTION

The present invention relates generally to the field of quality assurance and testing of applications. More particularly, the present invention relates to a system and a method to provide an interactive automated performance detection of one or more application programming interfaces.

Application testing has been used over the years as a tool for analyzing quality of a product or a service which the product or the service is designed to provide. Application development may not be possible if the product is not tested and quality assurance is not provided using one or more application testing procedures. Most of the applications rely on Application Programming Interfaces (APIs) for their functioning. Therefore testing performance of the APIs is a crucial step for development of the application.

Conventional technique to API testing, includes manual testing, which is further dependent on the skills of one or more testers involved in the process of manual testing. Conventional technique of manual testing is time consuming and lacks consistency and reliability as the testing steps are not standard and defined. Moreover, any error by one or more testers may lead to repeated testing of the API. To overcome the drawbacks of manual testing, automated testing techniques are explored.

Existing automated testing techniques involve a script recording process. This approach requires creation of a test script, where said test script performs one or more tests on the application programming interface. These scripts may be written in a general purpose programming language such as Visual Basic, C++ or Java, or in a proprietary language focused on test scripts. The scripts abstractly represent actions that are to be performed by the application programming interface under test. The scripts are then compiled and executed against the application programming interface under test. However, the existing automated testing techniques require one or more testers to have technical expertise to write, edit and execute scripts, which in turn restricts automated testing for non-technical testers. Further, the existing technique, may not work well in a real-time scenario as changes may be made to the application programing interfaces at regular intervals to improve performance and reliability.

In light of the above drawbacks, there is a need for a system and a method which provides interactive automated performance detection of one or more application programming interfaces. There is a need for a system and a method which does not involve writing of complicated scripts by a tester. There is a need for a system and a method which eliminates the need for a tester to have any technical expertise to use said system. Further, there is a need for a system and a method which supports multiple protocols for performance detection. Furthermore, there is a need for a system and a method which is inexpensive. Yet further, there is a need for a system and a method which can be easily deployed, maintained and can be easily learnt.

### SUMMARY OF THE INVENTION

A method for automating performance detection of one or more application programming interfaces is provided. In various embodiments of the present invention, the method is performed by a performance detection engine interfacing with an API subsystem, a test management database and a report database. The performance detection engine executes instructions stored in a memory via a processor. The method comprises generating, by the performance detection engine, one or more test requests from one or more test cases and associated test data retrieved for an API under test by retrieving one or more request templates from a request knowledgebase based on unique test case IDs associated with the retrieved one or more test cases. The method further comprises compiling one or more test cases and associated test data with the request template corresponding to respective test cases. Further the method comprises analyzing, by the performance detection engine, a response received from the API under test on execution of the one or more test requests, where the received response is compared with an actual response associated with the executed test request. Finally, the method comprises validating, by the performance detection engine, the response received from the API under test, where the API under test is labelled as defective if the response to the executed test does not match with the actual response.

In an embodiment of the present invention, retrieving one or more test cases and associated test data comprises analyzing, by the performance detection engine, an API under test from the one or more API's comprised by the API subsystem. Further, retrieving one or more test cases and associated test data from the test management database is based on a first set of rules. The first set of rules comprises examining the functions and protocols comprised by the API and evaluating the test cases based on said functions and protocols.

A system for automating performance detection of one or more application programming interfaces on invocation of a visual interface by an end-user is provided. In various embodiments of the present invention, the system interfaces with an API subsystem, a test management database and a report database. The system comprises a memory storing program instructions, a processor configured to execute program instructions stored in the memory, and a performance detection engine in communication with the processor. The performance detection engine is configured to generate one or more test requests from the retrieved one or more test cases and associated test data by retrieving one or more request templates from a request knowledgebase based on unique test case IDs associated with the retrieved one or more test cases. Further, the performance detection engine compiles one or more test cases and associated test data with the request template corresponding to respective test cases. Furthermore, the performance detection engine, analyzes a response received from the API under test on execution of the test request, where the received response is compared with an actual response associated with the executed test request. Finally, the performance detection engine, validates the response received from the API under test, where the API under test is labelled as defective if the response to the executed test does not match with the actual response.

A computer program product is provided. The computer program product comprises a non-transitory computer-readable medium having computer-readable program code stored thereon, the computer-readable program code comprising instructions that, when executed by a processor, cause the processor to generate one or more test requests from the retrieved one or more test cases and associated test data by retrieving one or more request templates from a request knowledgebase based on unique test case IDs associated with the retrieved one or more test cases and compiling one or more test cases and associated test data with the request template corresponding to respective test cases. Further, a response received from the API under test on execution of the test request is analyzed, where the received response is compared with an actual response associated with the executed test request. Finally, the response received from the API under test is validated, where the API under test is labelled as defective if the response to the executed test does not match with the actual response.

### BRIEF DESCRIPTION OF THE ACCOMPANYING DRAWINGS

The present invention is described by way of embodiments illustrated in the accompanying drawings wherein:

FIG. 1 illustrates a block diagram of a system for automating performance detection of one or more application programming interfaces of one or more applications, in accordance with an embodiment of the present invention;

FIG. 2 is a detailed block diagram of a performance detection subsystem for automating performance detection of one or more application programming interfaces of one or more applications, in accordance with an embodiment of the present invention;

FIG. 2a is an exemplary table depicting the test cases indexed by test case ID's, in accordance with an embodiment of the present invention;

FIG. 2b is an exemplary table depicting the test data associated with test cases, in accordance with an embodiment of the present invention;

FIG. 2c is an example of request template maintained in a request knowledgebase, in accordance with an embodiment of the present invention;

FIG. 2d is an example of a test request to make calls to an API, in accordance with an embodiment of the present invention;

FIG. 2e is an example of a response received from the API on execution of test request, in accordance with an embodiment of the present invention;

FIG. 3 is a flowchart illustrating a method for automating performance detection of one or more application programming interfaces of one or more applications, in accordance with an embodiment of the present invention; and

FIG. 4 illustrates an exemplary computer system in which various embodiments of the present invention may be implemented.

### DETAILED DESCRIPTION OF THE INVENTION

The present invention discloses a system and a method for automating performance detection of one or more application programming interfaces (APIs). In particular, the system and method of the present invention retrieves one or more test cases and associated test data as per respective test case ID's, generate one or more test requests by applying a data enrichment technique, executes one or more generated test requests on an API under test, analyses a response received from the API under test, performs response validation, detects any defects in the API based on the received response, and generates a detailed report of the executed test request. Further, the present invention provides an interface for selection of test cases, creating test cases, editing test cases, editing test requests, display execution of test requests and test reports.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

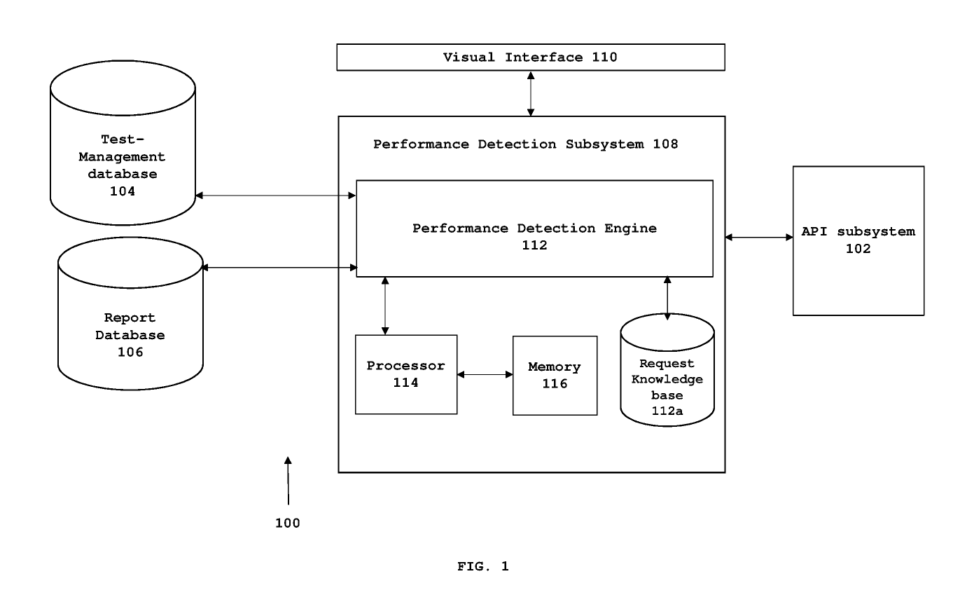

FIG. 1 illustrates a block diagram of a system for automating performance detection of one or more application programming interfaces of one or more applications, in accordance with an embodiment of the present invention. Referring to FIG. 1, in an embodiment of the present invention, the system 100 comprises an API subsystem 102, a test-management database 104, a report database 106, and a performance detection subsystem 108.

In an embodiment of the present invention, the API subsystem 102 may include any wired or wireless processing device capable of executing instructions. The API subsystem 102 is configured with one or more application programming interfaces (APIs). In another exemplary embodiment of the present invention the API subsystem may be a software module stored in computing device in a remote location. In an exemplary embodiment of the present invention, as shown in FIG. 1, the API subsystem 102 is an application interfacing with the performance detection subsystem 108 over a communication network (not shown). The application is configured to provide one or more services by receiving requests and responding to requests via one or more API's. For instance, the API subsystem may be a login application which validates user credentials and returns login status via a web service.

In various embodiments of the present invention, the test-management database 104 and the report database 106 are data storage devices. In an exemplary embodiment of the present invention, the test-management database 104 and the report database 106 may be remote to the performance detection subsystem 108. In an exemplary embodiment of the present invention, as shown in FIG. 1, the test-management database 104 is configured to maintain a knowledgebase of test cases and associated test data. The knowledgebase comprises test cases classified on the basis of unique test case ID. Further, each test case comprises a test scenario, a test case description, test steps, expected response, and actual response. Furthermore, one or more test cases may be created and stored in the test-management database 104. Yet further the existing test cases may be edited and maintained in the test-management database 104 via the performance detection subsystem 108.

The report database 106 is configured to store and maintain detailed reports of test requests executed on one or more API's of the API subsystem 102 by the performance detection subsystem 108. In an exemplary embodiment of the present invention, the test reports may be organized as per a level of severity of the result of executed test requests and the APIs under test.

In an exemplary embodiment of the present invention, as shown in FIG. 1, the performance detection subsystem 108 interfaces with the API subsystem 102 over a first communication channel (not shown). Further, the performance detection subsystem 108 interfaces with the test-management database 104 and the report database 106 over a second communication channel (not shown). The performance detection subsystem 108 retrieves one or more test cases and associated test data from the test-management database 104. Further the performance detection subsystem 108 executes tests on the one or more APIs of the API subsystem 102. Yet further, the performance detection subsystem 108 interfaces with the report database 106 to store and maintain the results of the executed test requests.

The performance detection subsystem 108 comprises a visual interface 110, a request knowledgebase 112a, a performance detection engine 112, a processor 114 and a memory 116. In various embodiments of the present invention, the visual interface 110 is a graphical user interface which allows user interaction with the performance detection engine 112. In an exemplary embodiment of the present invention, the visual interface 110 is configured with graphical icons to select various parameters of a test case, edit test data, edit test requests, display step by step execution of one or more test requests, display test results, create test cases in the test-management database 104, and edit test cases.

In various embodiments of the present invention, the request knowledgebase 112a is a collection of request templates supporting multiple protocols, where the request templates are indexed based on unique test case IDs associated with one or more test cases stored in the test-management database 104. Further, the examples of protocols supported by request templates includes but are not limited to SOAP, HTTP, JSON/REST, SWIFT, ACCORD and FIX.

In various embodiments of the present invention, the performance detection engine 112 is a self-learning engine configured to analyze one or more APIs to be tested, retrieve one or more test cases and associated test data and generate test requests. Further the performance detection engine 112 is configured to analyze a response received from the API under test, perform response validation, detect any defects in said API based on the received response, and generates a detailed report of the test for future use and debugging. In particular, the performance detection engine 112 is configured to retrieve one or more test cases and associated test data from the test-management database 104 as per respective test case ID's. In particular one or more test case IDs are selected via the visual interface 110. In an embodiment of the present invention, a test case comprises a test scenario, a test description, test steps, expected response and actual response. In an exemplary embodiment of the present invention, the data comprised by the retrieved one or more test cases may be edited via the visual interface 110.

In another embodiment of the present invention, the performance detection engine 112 analyses the API to be tested and retrieves relevant test cases and associated test data from the test-management database 104 based on a first set of rules. In said exemplary embodiment of the present invention, the first set rules comprises examining the functions and protocols comprised by the API and accordingly evaluating the test cases. In another embodiment of the present invention, the cases and associated test data may be stored and maintained in separate databases.

The performance detection engine 112 is further configured to generate appropriate test requests from the retrieved one or more test cases and associated test data by applying a data enrichment technique. The data enrichment technique includes retrieving the request templates stored in the request knowledgebase 112a based on unique test case IDs associated with the retrieved one or more test cases. Further, the data enrichment technique includes generating a test request by compiling a test case and associated test data with the request template associated with the said test case based on unique test case ID. The generated test request comprises information pertaining to test data, test scenario, test case description, test steps, expected response, and actual response. In an exemplary embodiment of the present invention, the generated test requests may be edited via the visual interface 110.

Further, the performance detection engine 112 is configured to arrange the generated one or more test requests in an order of preference. In an embodiment of the present invention, the order of preference may be selected via the visual interface 110. The performance detection engine 112 triggers each test request on the API under test in the order of preference.

Further, the performance detection engine 112 is configured to analyze and validate a response received from the API under test to the executed test request. In particular the performance detection engine 112 compares the received response with the actual response associated with the executed test request. The performance detection engine 112 performs response validation, where if the response to the executed test request is same as the actual response associated with the test request the API is labelled as working fine and if said responses do not match the API is labelled as defective.

The performance detection engine 112 is configured to analyze and validate a response received from the API under test to each executed test request in the order of preference. Yet further, the performance detection engine 112 is configured to generate a detailed report of the executed test requests on the basis of severity of the result of executed test requests. In an exemplary embodiment of the invention the detailed report is displayed via the visual interface 110.

In various embodiments of the present invention, the performance detection engine 112 has multiple units which work in conjunction with each other for automating performance detection of one or more application programming interfaces of one or more applications. The various units of the performance detection engine 112 are operated via the processor 114 specifically programmed to execute instructions stored in the memory 116 for executing respective functionalities of the units of performance detection subsystem 108 in accordance with various embodiments of the present invention.

In another embodiment of the present invention, the performance detection subsystem 108 may be implemented in a cloud computing architecture in which data, applications, services, and other resources are stored and delivered through shared data-centers. In an exemplary embodiment of the present invention, the functionalities of the performance detection subsystem 108 are delivered to a tester as software as a service (SAAS).

In another embodiment of the present invention, the performance detection subsystem 108 may be implemented as a client-server architecture, where the client terminal device is configured with a visual interface. The client terminal device accesses a server hosting the subsystem 108 over a communication channel. The communication channel may include a physical transmission medium, such as, a wire, or a logical connection over a multiplexed medium, such as, a radio channel in telecommunications and computer networking. The examples of radio channel in telecommunications and computer networking may include a Local Area Network (LAN), a Metropolitan Area Network (MAN), and a Wide Area Network (WAN).

In yet another embodiment of the present invention the performance detection subsystem 108 may be accessed through a web address via a client terminal device.

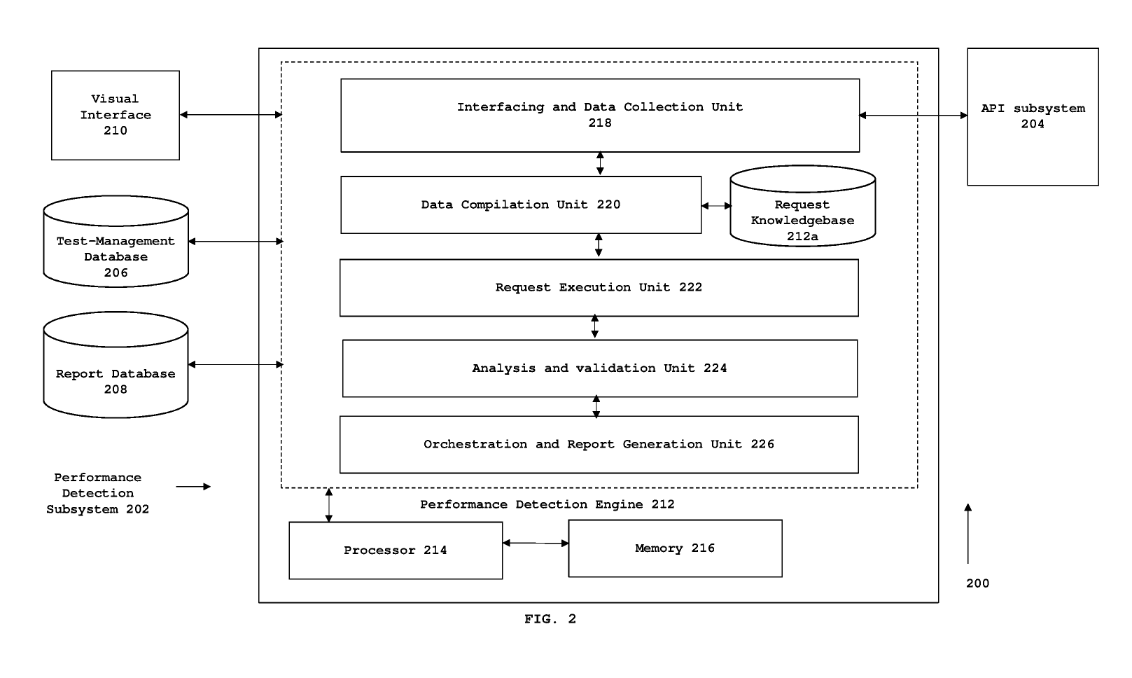

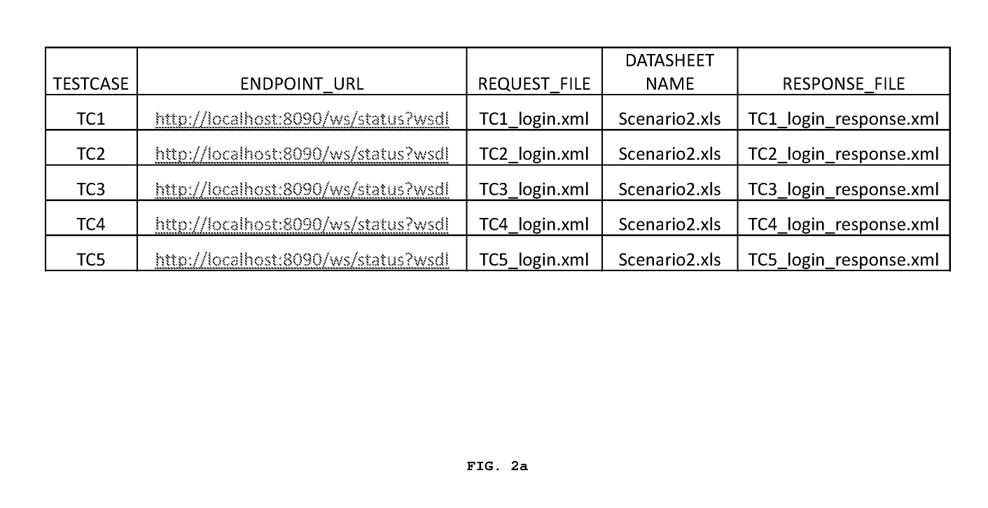

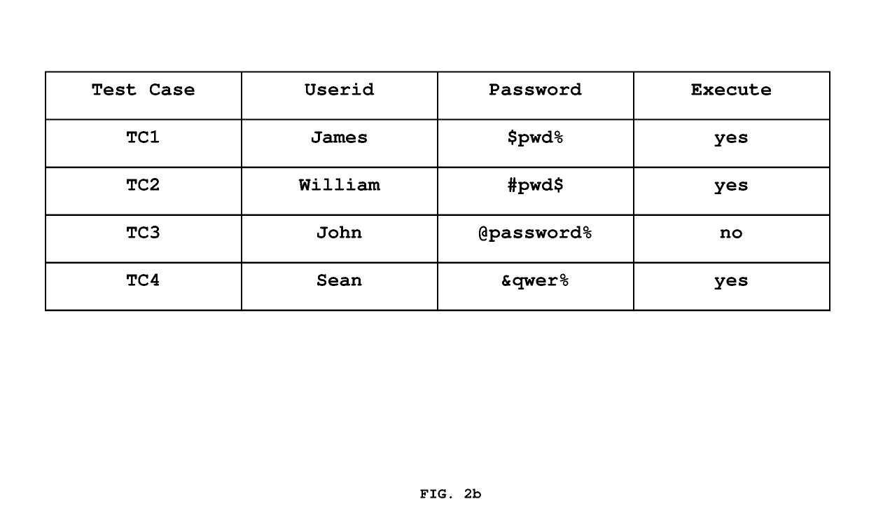

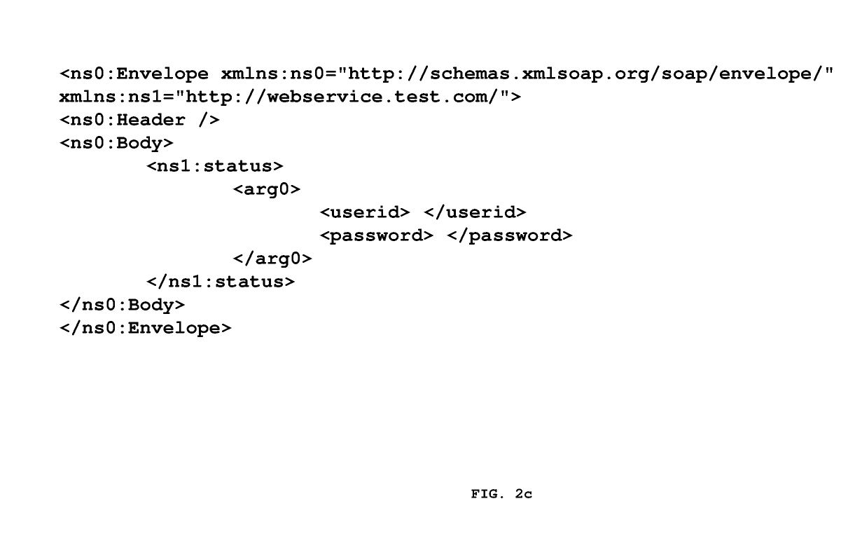

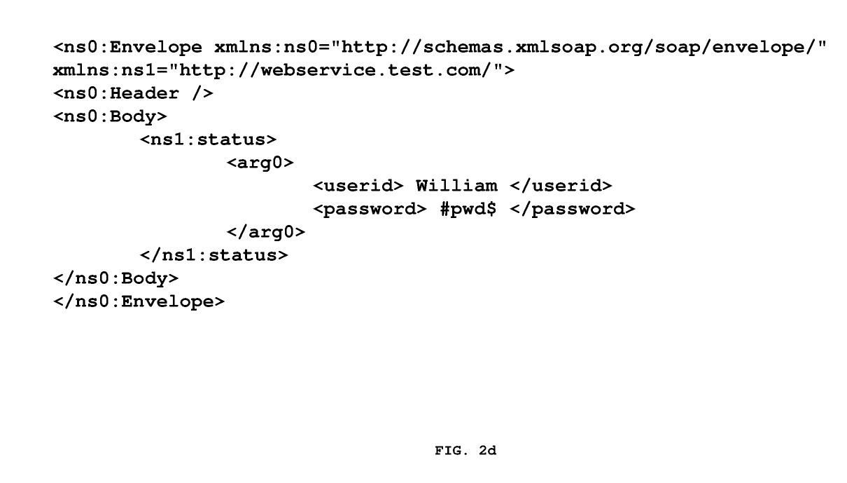

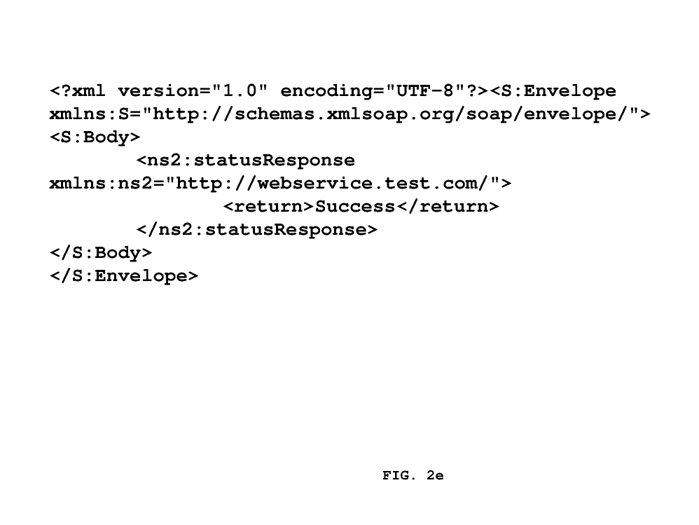

FIG. 2 is a detailed block diagram of a performance detection subsystem for automating performance detection of one or more application programming interfaces of more or more applications, in accordance with an embodiment of the present invention.

The performance detection subsystem 202 interfaces with an API subsystem 204, a test-management database 206 and a report database 208. The performance detection subsystem 202 interfaces with the test-management database 206 to retrieve one or more test cases and associated test data. Further the performance detection subsystem 202 executes tests on the one or more APIs of the API subsystem 204. Yet further, the performance detection subsystem 202 interfaces with the report database 208 to store and maintain the results of the executed test. The performance detection subsystem 202 comprises a visual interface 210, a request knowledgebase 112a, a performance detection engine 212, a processor 214 and a memory 216.

In various embodiments of the present invention, the visual interface 210 is a graphical user interface which allows user interaction with the performance detection engine 212. In an exemplary embodiment of the present invention, the visual interface 210 is configured with graphical icons to select one or more APIs to be tested, create test cases, select various parameters of a test case, edit test data, edit test requests, and display step by step execution of test requests and test results.

In various embodiments of the present invention, the request knowledgebase 112a is a collection of request templates supporting multiple protocols, where the request templates are indexed based on unique test case IDs associated with one or more test cases stored in the test-management database 104. Further, the examples of protocols supported by request templates includes but are not limited to SOAP, HTTP, JSON/REST, SWIFT, ACCORD and FIX.

In an embodiment of the present invention, the performance detection engine 212 comprises an interfacing and data collection unit 218, a data compilation unit 220, a request execution unit 222, an analysis and validation unit 224, and an orchestration and report generation unit 226.

The interfacing and data collection unit 218 is configured to interact with the API subsystem 204 on invocation the visual interface 210 for testing one of more APIs of the API subsystem 204. Further, the interfacing and data collection unit 218 is invoked by the visual interface 210 to retrieve one or more test cases and associated test data from the test-management database 206. In particular one or more test case IDs are selected via the visual interface 210. The interfacing and data collection unit 218 retrieves the one or more test cases and test data associated with the selected one or more test case IDs. In an exemplary embodiment of the present invention, each test case includes test scenario, test case description, test steps, expected response, and actual response.

FIG. 2a shows an exemplary table depicting the test cases indexed by test case ID's, in accordance with an embodiment of the present invention. The test cases as shown in FIG. 2a comprise unique test case ID's, test scenario, endpoint URL, actual response and request file name for testing an API of a login application which validates user credentials. Further, an exemplary table depicting the test data associated with test cases, in accordance with various embodiments of the present invention is shown in FIG. 2b. The test data is indexed in the order of unique test case ID's and comprises user credentials to be used during testing.

Further, the interface and data collection unit 218, enables editing of test cases via the visual interface 210. In an exemplary embodiment of the present invention, the data comprised by the retrieved one or more test cases may be edited via the visual interface 210.

In another embodiment of the present invention, the interfacing and data collection unit 218 analyses an API to be tested amongst the one or more API's comprised by the API subsystem 204 and retrieves one or more test cases and associated test data from the test-management database 206 based on a first set of rules. In an exemplary embodiment of the present invention, the first set of rules comprises examining the functions and protocols comprised by the API and accordingly evaluating the test cases.

In an embodiment of the present invention, the data compilation unit 220 is configured to receive the one or more test cases and associated test data from the interfacing and data collection unit 218. The data compilation unit 220 generates appropriate test requests from the retrieved one or more test cases and associated test data by applying a data enrichment technique. The data enrichment technique includes retrieving the request templates stored in the request knowledgebase 112a based on unique test case IDs associated with the retrieved one or more test cases. Further, the data enrichment technique includes generating a test request by compiling a test case and associated test data with the request template associated with the said test case based on unique test case ID. The generated test request comprises information pertaining to test data, test scenario, test case description, test steps, expected response, and actual response. In an exemplary embodiment of the present invention, the generated test requests may be viewed, modified and executed via the visual interface 210.

An example of request template maintained in a request knowledgebase 112a, in accordance with an embodiment of the present invention is shown in FIG. 2c. The request template as shown in FIG. 2c is for making a call to the API of the login application which validates user credentials. Further, data enrichment technique is performed on the request template to generate a test request as shown in FIG. 2d. The test request is generated by compiling the test case as shown in FIG. 2a and associated test data as shown in FIG. 2b with the request template as shown in FIG. 2c.

The request execution unit 222 is configured to receive the one or more test requests from the data compilation unit 220. The request execution unit 222 arranges the generated one or more test requests in an order of preference. In an embodiment of the present invention, the order of preference may be selected via the visual interface 210. Further, the request execution unit 222 triggers the first test request on the API under test in the order of preference. Yet further, the request execution unit 222, displays an execution window via the visual interface 210 to display each step being performed during execution of a particular test request facilitating easy debugging of the API under test. FIG. 2e is an example of a response received from the API on execution of test request, in accordance with an embodiment of the present invention. The response shows the validation of user credentials by the login application and returns the login status as successful.

The analysis and validation unit 224 is configured to analyze and validate a response received on execution of test request from the API under test. The analysis and validation unit 224 compares the received response with the actual response associated with the executed test request. Further, the analysis and validation unit 224 performs response validation where if the response to the executed test request is same as the actual response associated with the test request the API is labelled as working fine and if said responses do not match the API is labelled as defective. Yet further, the analysis and validation unit 224 provides a debug mode via the visual interface 210 to correct errors in the API under test.

Further, the request execution unit 222, triggers each test request on the API under test in the selected order of preference and the analysis and validation unit 224 is analyzes and validates the responses received from the API under test to each executed test request.

The orchestration and report generation unit 226 is configured to receive one or more responses validated by the request execution unit 222. Further, the orchestration and report generation unit 226 is configured to generate a detailed report of the executed test requests. In an exemplary embodiment of the present invention the detailed report is displayed via the visual interface 210. The orchestration and report generation unit 226 is configured to display a result window via the visual interface 210. In an exemplary embodiment of the present invention, the result window comprises a portion with a list of executed test requests and a test request description portion providing further details associated with the executed test requests. In said exemplary embodiment of the present invention, the report is classified based on the levels of severity of the result of executed test requests including errors, warnings, and informational messages. Categorization of such levels is user-controllable via the visual interface 210.

Further, the result window includes a print dialog which permits a user to print test reports. The print dialog allows selection of information from the detailed report for printing. For example, users may select to print all associated screens, or only selected items.

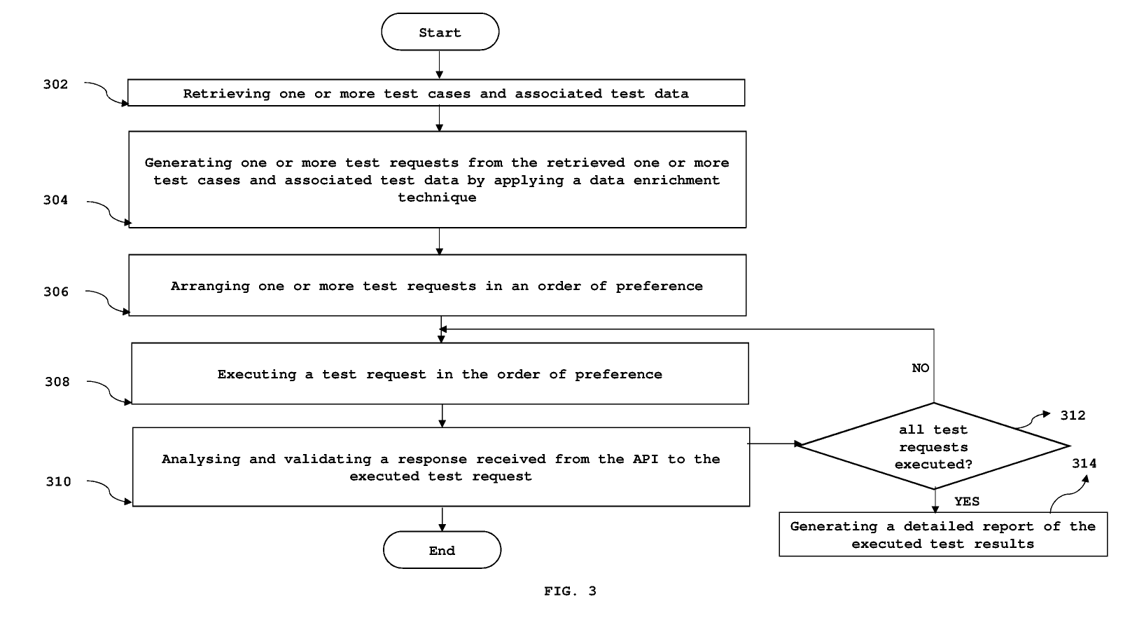

FIG. 3 is a flowchart illustrating a method for automating performance detection of one or more application programming interfaces of one or more applications, in accordance with an embodiment of the present invention.

At step 302, one or more test cases and associated test data are retrieved. In an embodiment of the present invention, one or more test cases and associated test data are retrieved from a test-management database 206 (as shown in FIG. 2). The one or more test cases may be retrieved based on respective test case ID's, where the test case IDs may be selected via a visual interface. In another embodiment of the present invention, an API to be tested is analyzed and one or more test cases and associated test data are retrieved from the test-management database 206 (FIG. 2) based on a first set of rules. In an exemplary embodiment of the present invention, the first set of rules comprises examining the functions and protocols comprised by the API and evaluating the test cases based on said functions and protocols. In an exemplary embodiment of the present invention, each test case may include a test scenario, a test case description, test steps, an expected response, and an actual response.

At step 304, one or more test requests are generated from the retrieved one or more test cases and associated test data by applying a data enrichment technique. In an exemplary embodiment of the present invention, the data enrichment technique includes retrieving one or more request templates stored in a request knowledgebase 212a (as shown in FIG. 2) based on unique test case IDs associated with the retrieved one or more test cases. Further, the data enrichment technique includes generating a test request by compiling a test case and associated test data with the request template associated with said test case based on unique test case ID. The generated test request comprises information pertaining to test data, test scenario, test case description, test steps, expected response, and actual response. In an exemplary embodiment of the present invention, the generated test requests may be edited via the visual interface.

At step 306, one or more test requests are arranged in an order of preference. In an embodiment of the present invention, the order of preference may be selected via the visual interface. At step 308, a test request is executed on the API under test based on the order of preference.

At step 310, a response received from the API on execution of the test request is analyzed and validated. In exemplary embodiment of the present invention, the received response is compared with the actual response associated with the executed test request. Further, response validation is performed, where if the response to the executed test request is same as the actual response associated with the test request the API is labelled as working fine and if said responses do not match the API is labelled as defective.

At step 312, a check is performed to determine if all the test requests have been executed. At step 314 if it is determined that all the test requests have been executed a detailed report of the executed test requests is generated. In an exemplary embodiment of the invention the detailed report is displayed via the visual interface.

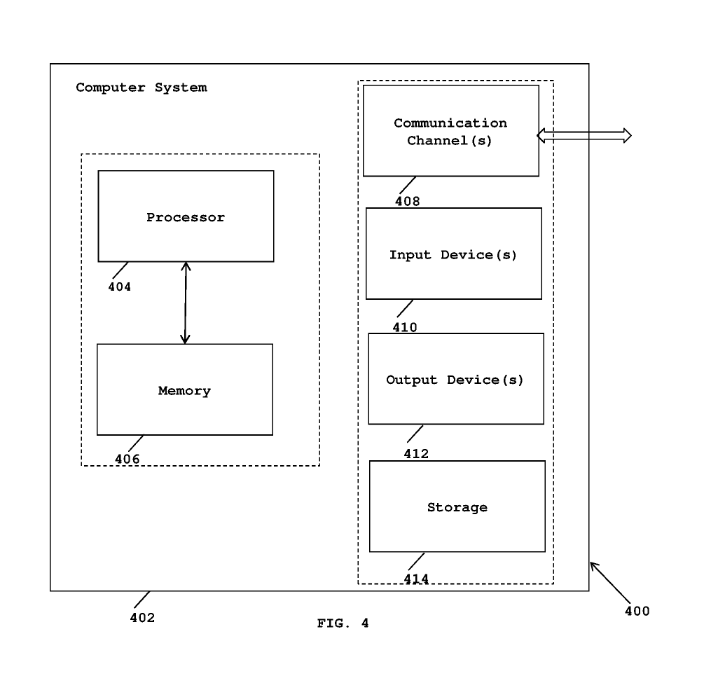

FIG. 4 illustrates an exemplary computer system in which various embodiments of the present invention may be implemented. The computer system 402 comprises a processor 404 and a memory 406. The processor 404 executes program instructions and is a real processor. The computer system 402 is not intended to suggest any limitation as to scope of use or functionality of described embodiments. For example, the computer system 402 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 406 may store software for implementing various embodiments of the present invention. The computer system 402 may have additional components. For example, the computer system 402 includes one or more communication channels 408, one or more input devices 410, one or more output devices 412, and storage 414. An interconnection mechanism (not shown) such as a bus, controller, or network, interconnects the components of the computer system 402. In various embodiments of the present invention, operating system software (not shown) provides an operating environment for various softwares executing in the computer system 402, and manages different functionalities of the components of the computer system 402.

The communication channel(s) 408 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 410 may include, but not limited to, a keyboard, mouse, pen, joystick, trackball, a voice device, a scanning device, touch screen or any another device that is capable of providing input to the computer system 402. In an embodiment of the present invention, the input device(s) 410 may be a sound card or similar device that accepts audio input in analog or digital form. The output device(s) 412 may include, but not limited to, a user interface on CRT or LCD, printer, speaker, CD/DVD writer, or any other device that provides output from the computer system 302.

The storage 414 may include, but not limited to, magnetic disks, magnetic tapes, CD-ROMs, CD-RWs, DVDs, flash drives or any other medium which can be used to store information and can be accessed by the computer system 402. In various embodiments of the present invention, the storage 414 contains program instructions for implementing the described embodiments.

The present invention may suitably be embodied as a computer program product for use with the computer system 402. The method described herein is typically implemented as a computer program product, comprising a set of program instructions which is executed by the computer system 402 or any other similar device. The set of program instructions may be a series of computer readable codes stored on a tangible medium, such as a computer readable storage medium (storage 414), for example, diskette, CD-ROM, ROM, flash drives or hard disk, or transmittable to the computer system 402, via a modem or other interface device, over either a tangible medium, including but not limited to optical or analogue communications channel(s) 408. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

1. A method for automating performance detection of one or more application programming interfaces, performed by a performance detection engine interfacing with an API subsystem, a test management database and a report database, the performance detection engine executing instructions stored in a memory via a processor, said method comprising:
generating, by the performance detection engine, one or more test requests for an API under test by:
retrieving one or more test cases and associated test data from a knowledge base, wherein the test cases and associated test data are classified based on respective unique test case identifications (IDs) and are pre-stored in the knowledge base,
by retrieving one or more request templates from the request knowledge base based on the unique test case IDs associated with the retrieved test cases, wherein the request templates support multiple protocols and the request templates are indexed based on the unique test case IDS associated with the one or more test cases,
and compiling the retrieved test cases and associated test data with the retrieved request templates based on the unique test case IDS;
analyzing, by the performance detection engine, a response received from the API under test on execution of the one or more test requests, wherein the received response is compared with an actual response associated with the executed test request; and
validating, by the performance detection engine, the response received from the API under test, wherein the API under test is labelled as defective if the response to the executed test does not match with the actual response.

2. The method as claimed in claim 1, wherein retrieving one or more test cases and associated test data comprises analyzing, by the performance detection engine, an API under test from the one or more API's comprised by the API subsystem and retrieving one or more test cases and associated test data from the test management database based on a first set of rules, wherein the first set of rules comprises examining the functions and protocols comprised by the API and evaluating the test cases based on said functions and protocols.

3. The method as claimed in claim 1, wherein the test cases are edited via a visual interface by an end-user via a client device.

4. The method as claimed in claim 1, wherein the one or more test requests are arranged for execution in an order of preference and edited on invocation by the visual interface by an end-user via the client device.

5. The method as claimed in claim 1, wherein the generated test request comprises information associated with test data, test scenario, test case description, test steps, expected response, and actual response.

6. The method as claimed in claim 1, wherein a check is performed to determine if all the test requests have been executed and a detailed report of the executed test requests is generated.

7. A system for automating performance detection of one or more application programming interfaces on invocation of a visual interface by an end-user, said system interfacing with an API subsystem, a test management database and a report database, the system comprising:
a memory storing program instructions; a processor configured to execute program instructions stored in the memory; and a performance detection engine in communication with the processor and configured to:
generate one or more test requests from for an API under test from by retrieving one or more test cases and associated test data and by retrieving one or more request templates from a request knowledgebase based on unique test case IDs associated with the retrieved one or more test cases, wherein the request templates support multiple protocols and the request templates are indexed based on the unique test case IDS associated with the one or more test cases, and compiling the retrieved test cases and associated test data with the request template corresponding to respective test cases;
analyze a response received from the API under test on execution of the test request, wherein the received response is compared with an actual response associated with the executed test request; and
validate the response received from the API under test, wherein the API under test is labelled as defective if the response to the executed test does not match with the actual response.

8. The system as claimed in claim 7, wherein the visual interface allows interaction with the performance detection engine and is configured with graphical icons to select one or more APIs from the API subsystem, create test cases, select one or more parameters of a test case, edit test data, edit test requests, and display step by step execution of test requests and test results.

9. (canceled)

10. The system as claimed in claim 1, wherein the protocols supported by request templates are selected from SOAP, HTTP, JSON/REST, SWIFT, ACCORD and FIX.

11. The system as claimed in claim 7, wherein the performance detection engine comprises an interfacing and data collection unit in communication with the processor, said interfacing and data collection unit configured to interact with the API subsystem for testing one of more APIs comprised by the API subsystem, and retrieve one or more test cases and associated test data from the test-management database.

12. The system as claimed in claim 11, wherein a test case comprises a test scenario, a test description, test steps, expected response and actual response.

13. The system as claimed in claim 7, wherein the performance detection engine comprises a data compilation unit in communication with the processor, said data compilation unit configured to generate test requests from the retrieved one or more test cases and associated test data by applying a data enrichment technique, wherein each generated test request comprises information associated with test data, test scenario, test case description, test steps, expected response, and actual response.

14. The system as claimed in claim 7, wherein the performance detection engine comprises a request execution unit in communication with the processor, said request execution unit is configured to arrange the generated one or more test requests in the order of preference, trigger said one or more test requests in the order of preference and determine if all the test requests have been executed.

15. The system as claimed in claim 7, wherein the performance detection engine comprises an analysis and validation unit in communication with the processor, said analysis and validation unit is configured to analyze and validate response received on execution of one or more test request from the API under test, wherein the received response is compared with the actual response associated with the executed test request and the API under test is labelled as working fine, if the response to the executed test request is same as the actual response associated with the test request.

16. The system as claimed in claim 15, wherein the API under test is labelled as defective if the response to the executed test request do not match with the actual response associated with the test request.

17. The system as claimed in claim 16, wherein the analysis and validation unit provides a debug mode via the visual interface to correct errors in the API under test.

18. The system as claimed in claim 7, wherein the performance detection engine comprises an orchestration and report generation unit in communication with the processor, said orchestration and report generation unit is configured to generate a detailed report of the executed test requests and display a result window via the visual interface, wherein the result window comprises a portion with a list of executed test requests and a test request description portion providing details of the executed test requests.

19. The system as claimed in claim 18, wherein the report is classified based on severity of the result generated based on the executed test requests including errors, warnings, and informational messages.

20. The system as claimed in claim 18, wherein the result window includes a print dialog to print test reports, wherein the print dialog allows selection of information from the detailed report for printing.

21. A computer program product comprising:
a non-transitory computer-readable medium having computer-readable program code stored thereon, the computer-readable program code comprising instructions that, when executed by a processor, cause the processor to:
generate one or more test requests for an API under test by retrieving one or more test cases and associated test data and by retrieving one or more request templates from a request knowledgebase based on unique test case IDs associated with the retrieved one or more test cases, wherein the request templates support multiple protocols and the request templates are indexed based on the unique test case IDS associated with the one or more test cases, and compiling the retrieved test cases and associated test data with the request template corresponding to respective test cases;
analyze a response received from the API under test on execution of the test request, wherein the received response is compared with an actual response associated with the executed test request; and
validate the response received from the API under test, wherein the API under test is labelled as defective if the response to the executed test does not match with the actual response.
